(19) United States
(12) Patent Application Publication
(10) Pub. No.: US 2022/0300040 A1
(43) Pub. Date: Sep. 22, 2022

(54) SYSTEM AND METHODS FOR CONTROLLING INPUTS TO A CAPACITANCE INTERFACE

(71) Applicant: Pioneer & Co., Inc. d/b/a Pioneer Research, Moorestown, NJ (US)

(72) Inventor: Bjorn Harms, Cherry Hill, NJ (US)

(73) Assignee: Pioneer & Co., Inc. d/b/a Pioneer Research, Moorestown, NJ (US)

(21) Appl. No.: 17/700,262

(22) Filed: Mar. 21, 2022

Related U.S. Application Data
(60) Provisional application No. 63/163,250, filed on Mar. 19, 2021.

(51) Int. Cl. G06F 1/16; G06F 3/044

(52) U.S. Cl. CPC G06F 1/1656; G06F 3/044; G06F 1/1698

(57) ABSTRACT

An underwater case contains a device for use in wet and dry conditions, such as underwater, extreme hot or cold conditions, or the like. The underwater case includes one or more waterproof seals to keep a contained device safe. The case includes a controller including a non-volatile memory and processor, a radio module configured to provide a short-range wireless connection between the controller and the device and an integrated connection module configured to activate the device. The case includes an input component connected to the controller and configured to receive one or more inputs from a user and transmit, via the short-range wireless connection, instructions to the device based on the one or more inputs.

### PRIORITY

This application claims the benefit of U.S. Provisional 63/163,250, filed Mar. 19, 2021, which is hereby incorporated by reference.

### FIELD OF THE INVENTION

The present invention relates to an underwater device, and, more particularly, to system and methods for controlling inputs to a capacitance interface.

### BACKGROUND

Today's smartphone devices, such as an iPhone® or an Android® device, are marketed as being dust-resistant and/or water-resistant. Typically, a water or dust resistant device will be provided with a rating that indicates how long a device may be submerged without suffering from any type of damage. For example, a device may be provided with a rating of IP68, which is an international standard rating indicating that the device is resistant to submersion up to a maximum depth of 1.5 meters underwater for up to 30 minutes.

Additionally, capacitive touchscreens do not function in underwater conditions. A smartphone's display's electrical field is grounded by the water and therefore touching it will have no effect. A flexible membrane with oil-filled dielectric layer or air gap over the display may allow manipulating of a touchscreen but has depth limitations.

What is needed is a waterproofing solution for smartphone devices to enable usage of the devices in underwater environments for extended periods of time. While prior art solutions have allowed for the manipulation of a touchscreen in wet environments, these solutions typically rely on flexible membranes and/or oil-filled dielectric layers which do not work at great depths.

### BRIEF SUMMARY

The present embodiments may relate to, inter alia, systems and methods for providing a wireless mouse interface with a smartphone/tablet and remote controls application but integrated into an underwater case. The cursor-moving, selection-making device may be anything that moves the smartphone/tablet's cursor in a X and Y manner, like an optical or mechanical trackball, mouse, joystick, touchpad or up/down/left/right buttons, or the like. The user may control an input device on the interface of the case to move the cursor and select objects/functions on the smartphone/tablet, allowing the user to remotely operate native applications installed on a smartphone/tablet that is sealed inside the underwater case.

In an embodiment of the present invention an underwater case for containing a device may comprise a device comprising at least one of, a camera, mobile telephones, smartphones, and tablets, a controller arranged on a portion of an underwater case for activating said device when the device is positioned internally of the underwater case, the underwater case comprising an integrated connection module in wireless mode for activating the device by the controller, a door for closing the underwater case, provided with a transparent screen, made of a plastic, glass, or other transparent material, for viewing said device inside the underwater case; wherein the underwater case further includes a radio frequency module for supporting a Bluetooth standard, and wherein data exchange between the underwater case and the device takes place using the Bluetooth® standard, and at least one selection device in communication with the controller for controlling at least one feature of the device.

The present invention may also provide a method for using a device in an underwater environment, the method comprising placing a smartphone in a case having at least one waterproof seal, paring the smartphone with a controller comprising a non-volatile memory and processor, the controller comprising, a radio module configured to provide a short-range wireless connection between the controller and the device, and an integrated connection module configured to activate the device, and receiving one or more inputs from a user through an input component connected to the controller, and transmitting an instruction to the device based on the one or more inputs.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates circuitry of an exemplary portable computing device in accordance with one embodiment of the present disclosure.

FIG. 2 illustrates a rear view of an exemplary case 202 in accordance with an embodiment of the present disclosure.

FIG. 3 illustrates an alternative rear view of the exemplary case 202 in accordance with another embodiment of the present disclosure.

FIG. 4 illustrates another alternative rear view of the exemplary case 202 in accordance with another embodiment of the present disclosure.

FIG. 5 illustrates yet another alternative rear view of the exemplary case 202 in accordance with another embodiment of the present disclosure.

FIG. 6 illustrates an exemplary front view of the exemplary case 202 in accordance with another embodiment of the present disclosure.

FIG. 7 illustrates a side view of the exemplary case 202 in accordance with another embodiment of the present disclosure.

FIGS. 8A and 8B illustrate exemplary rear open views of the exemplary case 202 in accordance with yet another embodiment of the present disclosure.

FIG. 9 illustrates an exemplary case 202 with a lens holder accessory in accordance with yet another embodiment of the present disclosure.

FIG. 10 illustrates an exemplary process in accordance with at least one embodiment of the present disclosure.

### DETAILED DESCRIPTION

Reference will now be made in detail to the preferred embodiments of the present invention, examples of which are illustrated in the accompanying drawings. While the present invention will be described in conjunction with the preferred embodiments, it will be understood that they are not intended to limit the present invention to these embodiments. On the contrary, the present invention is intended to cover alternatives, modifications and equivalents, which may be included within the spirit and scope of the present invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Some portions of the detailed descriptions which follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, etc., is conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proved convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “implementing”, “outputting”, “generating”, “receiving”, “transmitting”, “determining”, “using” or the like, refer to the actions and processes of a computer system, or similar electronic device including a personal digital assistant (PDA). The computer system or similar electronic computing device manipulates and transforms data represented as physical (electronic) quantities within the computer system's registers and memories into other data similarly represented as physical quantities within the computer system memories or registers or other such information storage, transmission, or display devices.

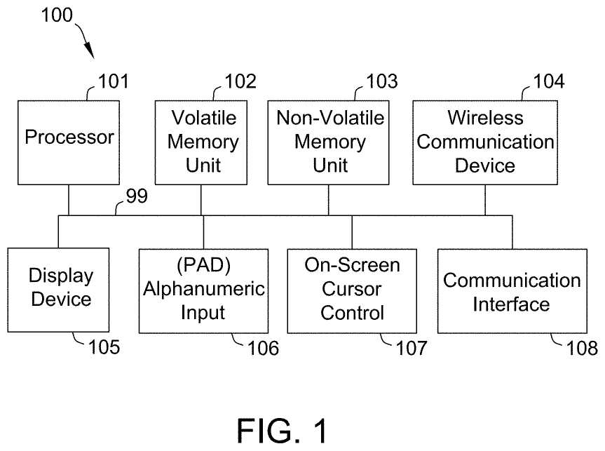

With reference now to FIG. 1, it should be appreciated that portions of the present method and system are comprised of computer-readable and computer-executable instructions which reside, for example, in computer-usable media of a portable computer system. FIG. 1 illustrates an exemplary portable computer system 100. It is appreciated that system 100 of FIG. 1 is only exemplary and that the present invention can operate within a number of different portable computing devices, personal digital assistants (PDAs), pager, portable telephone, and the like.

FIG. 1 illustrates circuitry of an exemplary portable computing device 100 in accordance with one embodiment of the present invention. Portable computer system 100 includes an address/data bus 99 for communicating information, a central processor 101 coupled with the bus 99 for processing information and instructions, a volatile memory unit 102 (e.g., random access memory, static RAM, dynamic RAM, etc.) coupled with the bus 99 for storing information and instructions for the central processor 101 and a non-volatile memory unit 103 (e.g., read only memory, programmable ROM, flash memory, EPROM, EEPROM, etc.) coupled with the bus 99 for storing static information and instructions for the processor 101. Computer system 100 also includes a wireless communication device 104 coupled to the bus 99 for wirelessly transmitting and receiving information from other devices. It should be understood that wireless communication device 104 may include radio frequency (RF) technology such as Bluetooth communication technology, IEEE 802.11 technology, or HomeRF technology. Wireless communication device 104 can also include an infrared communication port. System 100 also contains a display device 105 coupled to the bus 99 for displaying information to the portable computer user.

Also included in portable computer device 100 of FIG. 1 is an optional alphanumeric input device 106 which in one implementation is a handwriting recognition pad (“digitizer”) having different regions, for instance. Device 106 can communicate information and command selections to the central processor 101. System 100 also includes an optional cursor control or directing device 107 coupled to the bus 99 for communicating user input information and command selections to the central processor 101. In one implementation, device 107 includes a touch screen interface incorporated with screen 105. Device 107 may be capable of registering a position on the screen 105 where a stylus makes contact, for example, or may be controlled by an application running on device 107. The display device 105 utilized with the computer system 100 may be a liquid crystal device (LCD) or other display device suitable for creating graphic images and alphanumeric characters recognizable to the user. Portable computer system 100 also includes a communication interface 108, which is also coupled to bus 99, and can be a serial port for communicating with a cradle (not shown) for system 100.

In some embodiments the underwater case may be designed to fit most smartphones/tablets. Once the smartphone/tablet is sealed inside the waterproof case, the user cannot touch the smartphone/tablet side buttons or touchscreen display. The following solution allows the user to remotely control and operate native applications on the smartphone/tablet when it is sealed inside the underwater case. The underwater case may have an integrated Bluetooth®, near-field communications (NFCs) and/or any radio frequency transmitter used to wirelessly connect, communicate with and control applications on a smartphone/tablet.

The underwater case may have an integrated controller that is used to remotely move the cursor on the smartphone/tablet display in a X and Y manner and select the object/function on the smartphone/tablet. This may be, for example, an X-Y-axis or x-y-z-axis movement device, like an optical or mechanical trackball, mouse, joystick, touchpad or up/down/left/right buttons. The user may move the cursor on the display interface on the underwater case, which, in turn, moves the cursor in the same direction on the smartphone/tablet display. As the cursor hovers over the intended touch screen target, the user may remotely select the target to operate the application.

Selecting (“clicking”) the target may be achieved in a couple of ways. The input cursor may have Z-axis movement, so pushing or pulling the cursor may send a select command to the smartphone/tablet. A separate button, lever or switch integrated into the underwater case may be used to send select command to the smartphone/tablet.

In some embodiments, a user may control an input cursor via a joystick. For example, an input cursor on an interface of the underwater case may move on an x-y axis corresponding to input by a user of the device. Via the joystick, the user may perform a selection operation to control a native application of the smartphone device, as described herein.

The underwater case may have one or more waterproof seals that function to separate wet mechanical areas from dry electronic areas of the device. In some embodiments, the case may remotely operate native smartphone/tablet applications. For example, the underwater case may remotely operate applications including, but not limited to, camera app, photo/video gallery app, music app, 3D scanning app, movie app, sound recorder app, Settings app, etc. Radio waves do not travel through water, and thus the wireless underwater case must be integrated into the underwater case in such a way that little to no water comes between the smartphone/tablet and an integrated controller of the case whilst in the underwater environment.

It will be appreciated by those skilled in the art that the case described herein may be an underwater case but may also be suitable for other applications where a mobile device, for example needs to be in a sealed case. For example, the case may be used in any environment that could experience extremes in temperature and/or debris or fluids. Examples include, but are not limited to, industrial sites that create dust, meat processing plants, chemical manufacturing, crime scenes, construction sites, food preparation, and the like.

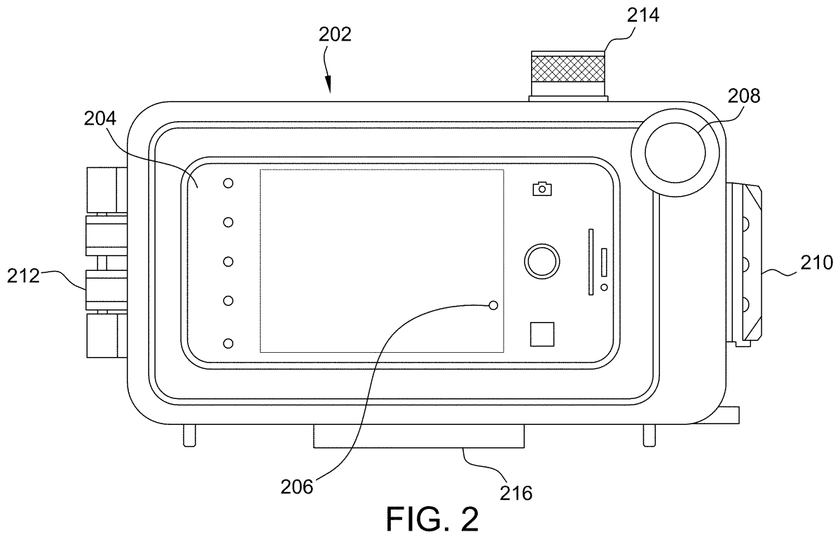

FIGS. 2-5 illustrate a rear view of an exemplary case 202 in accordance with multiple embodiments. As shown, exemplary case 202 encapsulates device 204. Once a connection is established between case 202 and device, such as via a short-range wireless connection, a user may be provided with an interface and shown cursor 206. Cursor 206 may be controlled via an input control component, such as trackball 208. The underwater case 202 may include a door that may be sealed using an open/close mechanism 210 via door hinge 212. Alternatively, the door may be a rear transparent cover that may be attached to the case via one or more latches, screws, or the like. In some embodiments, the door may be a side-entry waterproof door or cover. The door, which serves as the rear wall of case 202, may include a transparent window to provide a clear view of device 204's screen. Mechanism 210 may include, for example, a cam-action closing lock to seal case 202 shut. Alternatively, the closing lock may be any type of latch mechanism or screw that secures the door/cover to create a waterproof seal. Port 214 provides a vacuum pressure port. In some embodiments, port 214 may be used to conduct leak test analysis of the case. Tripod mount 216 may provide for the attachment of different accessories. Accessories may include, but are not limited to, a tripod, a selfie-stick, a handheld mount, or the like.

Although the use of a hinge is discussed herein, the case may not comprise a hinge. For example, the case may still comprise two pieces that may be joined be mechanical means such as clips, locks, screws, and other mechanical attachment means. Similarly, the case pieces may be joined by magnetics or other non-mechanical means. The case may also allow for the side insertion of a device and may, for example, be a unitary case have a door or other removeable, or partially removable, side which would allow a device to be eventually enclosed by the case.

As described, device 204 may include, but is not limited to, a smartphone device, a tablet device, a camera, underwater equipment, PDA, or the like. Input control components may include, but are not limited to, trackballs, remove input devices, a joystick, trackpad, or the like.

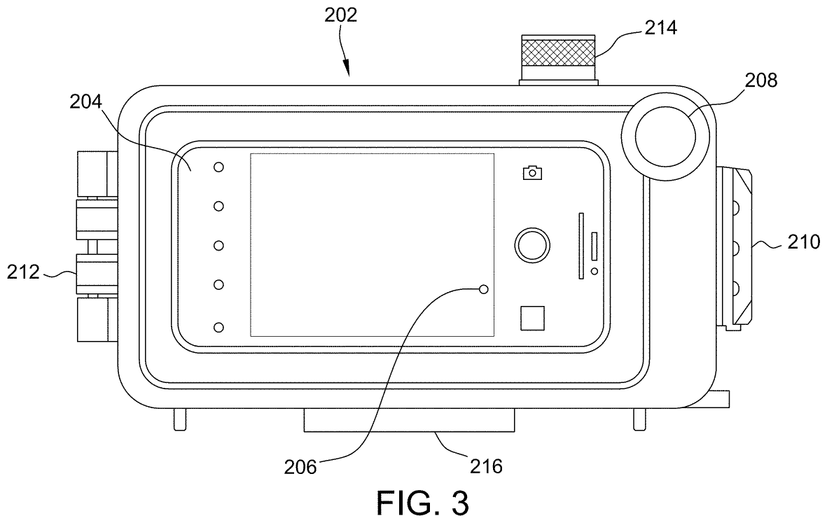

As illustrated in FIG. 3, cursor 206 may mimic movement of trackball 208. In some embodiments, a user may use trackball 208 to move the cursor and make input selections on the encapsulated device 204. Selections may be made by the trackball itself or via another button, switch, lever, or the like. Using trackball 208, a user may hover over a certain target area on the interface. A selection may be made within the target area to perform a function. For example, the user may open an app on the encapsulated device. Additionally, or alternatively, the user may select an icon or target area within an opened app to perform an action. An action may be, for example, selecting an icon to take a picture within a camera app, changing settings with an app, or the like.

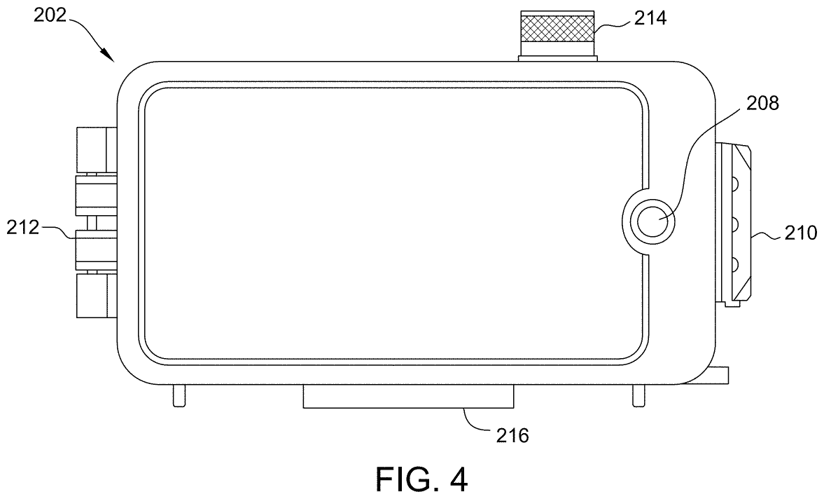

As illustrated in FIG. 4, exemplary case 202 may include a joystick 208 to perform input selections. As described above in FIG. 3, a user of case 202 may control operations of a device 204 via a cursor (not shown) using joystick 208. Joystick 208 may be used to move a cursor around a display screen and interact with device 204, as described above.

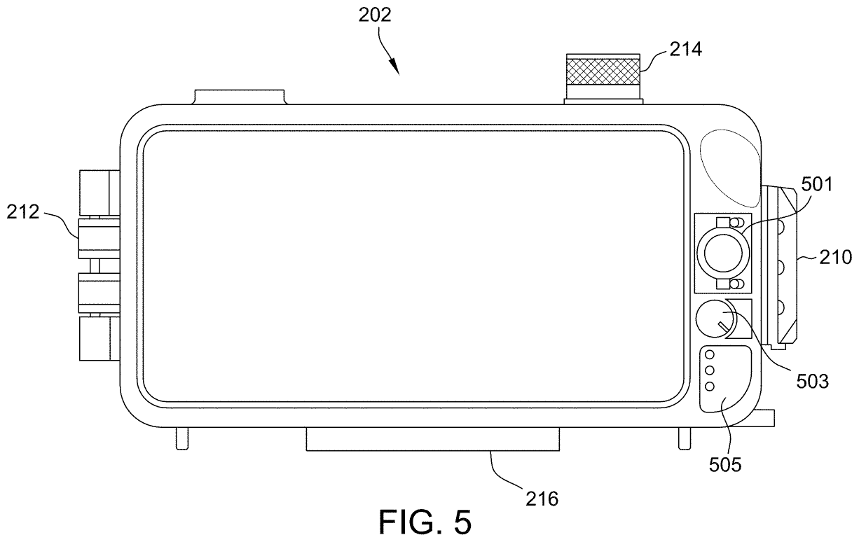

In some embodiments, FIG. 5 illustrates yet another alternative rear view of the exemplary case 202 in accordance with another embodiment of the present disclosure. In this example, additional features may be provided to allow further control of an encapsulated device 204. For example, an input device 501 is provided. Additionally, the input device may be a removable component. For example, input device 501 may be a removable joystick X-Y controller. Input device 501 may perform all of the functions described above and perform cursor movement to make selections on the interface of the encapsulated device.

In some embodiments, case 202 may include a dial 503. Dial 503 enables a device user to perform camera operations, for example, such as shutter operation. Additionally, or alternatively, dial 503 may be a selector dial. Further, case 202 may include one or more LED status indicator lights 505. LED status indicator lights may be used to convey different types of information to the user of the case. Conveyed information may include, but is not limited to, battery status of case 202, battery status of device 204, malfunction status, pressure status, leak event, or the like.

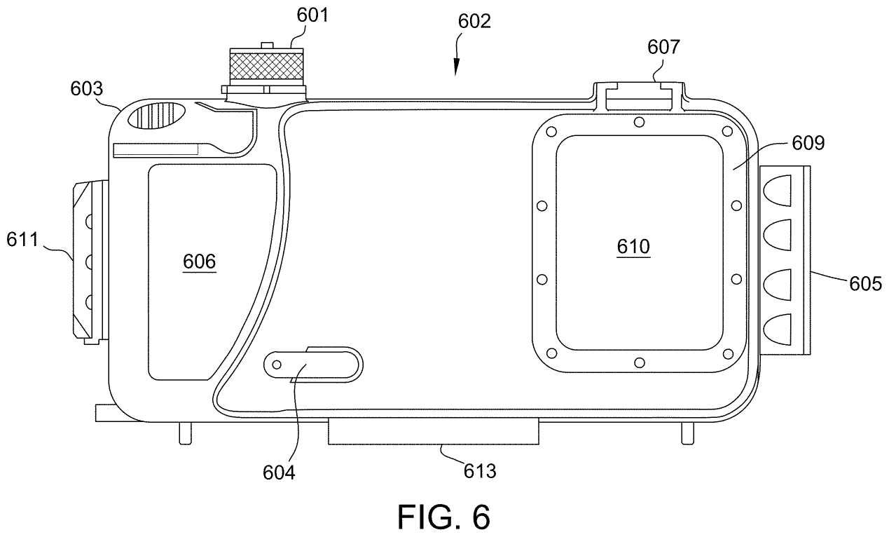

A front view of case 602 is shown in FIG. 6. Front view 602 includes a vacuum pressure port 601 for leak test analysis and a cold shoe 607 for mounting a photo-video light or other accessory. Additionally, case 202 may include a door hinge 605 having one or more grip indents and a lock 611. Lock 611 may include a rear door cam-action closing lock, for example. Additionally, or alternatively, case 602 may include a grip pad, an integrated pressure sensor 604, and a tripod mount 613. In some embodiments, the integrated pressure sensor may send pressure data to the integrated controller of case 602. Status of the device and case may be updated based on the pressure data and conveyed to the user. In one embodiment, the encapsulated device may be used as a dive computer which may utilize the pressure data operate properly. For example, pressure status may be conveyed to the user via lights 505, via the encapsulated device's screen, or a combination thereof. Additionally, or alternatively lights 505 may be used to convey certain important information, such power ON, Bluetooth® connected, low battery, leak detected, depth alarm, or the like. A lens frame 609 may be provided around a lens port 610, enabling an encapsulated device to capture images and/or other visual media.

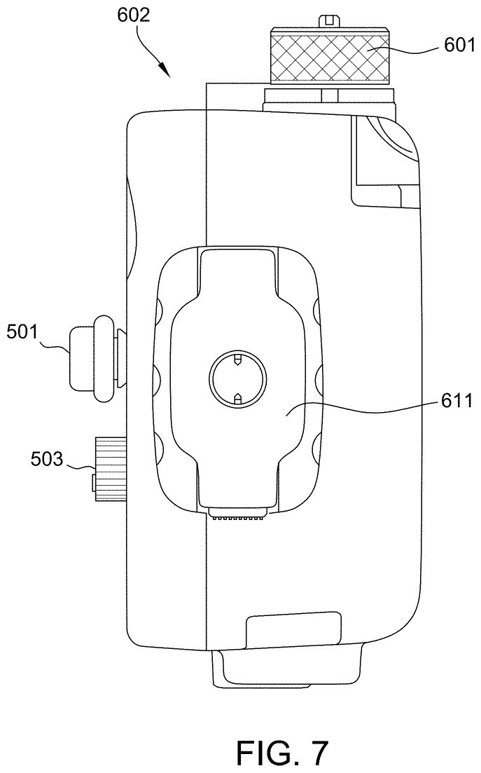

A side view of case 602 is shown in FIG. 7. As shown, case 602 may include a removable hall-effect joystick 501 with an X-Y axis cursor-moving action. Alternatively, an optical sensor or other mechanical design may be used to translate X-Y movement of joystick 501 to the device cursor. The joystick may be removed from case 602. Joystick 501 may be held in place by one or more slide locks, for example. When moved to an unlock position, the slide locks enable the release of the joystick from the case. Joystick 501 may be removed from the case for replacement, for cleaning, for repair, or the like.

Additionally, or alternatively, case 602 may include a shutter/select dial for assigning function to a shutter/select lever. For example, a shutter dial may enable a user of an encapsulated device to capture a photo or start/stop video, among other types of actions. Further, the select dial may enable the user to select an object, area, or icon on the encapsulated device's screen under a cursor.

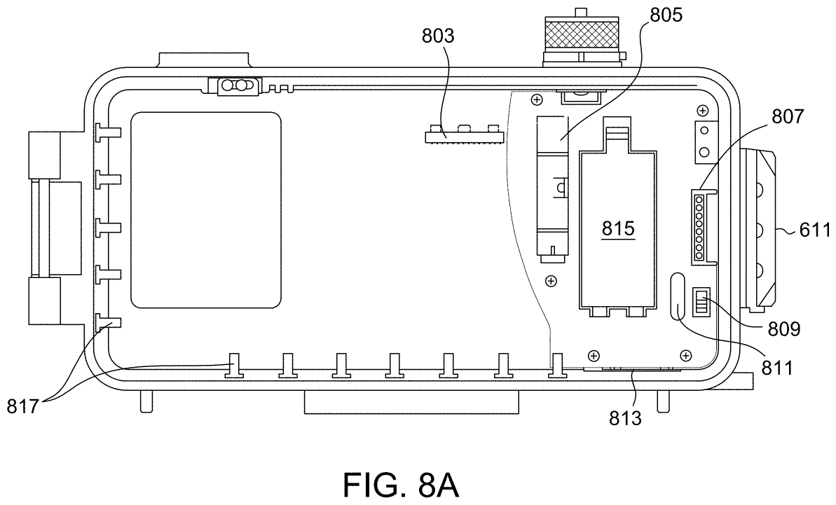

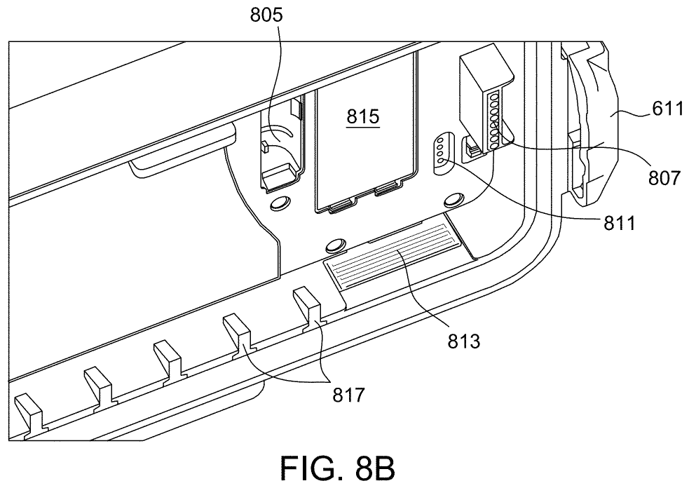

FIGS. 8A and 8B illustrate exemplary rear open views of the exemplary case showing internal components of the case. As shown in FIGS. 8A and 8B, a holding spring 803 is provided having a rubber grip pad to hold a device securely in place. Cavity 805 is provided to hold a desiccant, such as a Moisture Muncher® to prevent internal fogging. One or more electrical contacts 807 (i.e. pogo pins) may be provided for connecting one or more rear door controls to main body circuitry. The case may include an on/off power switch 809 to control power of the case, a firmware update port 811, a wet sensor 813 to detect water intrusion, and a battery compartment 815. Finally, the underwater case, in some embodiments, may include one or more removable rubber grip tabs 817. The rubber grip tabs may be tapered at an angle to hold a device in place. Additionally, or alternatively, rubber grip tabs 817 may differ in size based on a device's size (e.g., S, M, L).

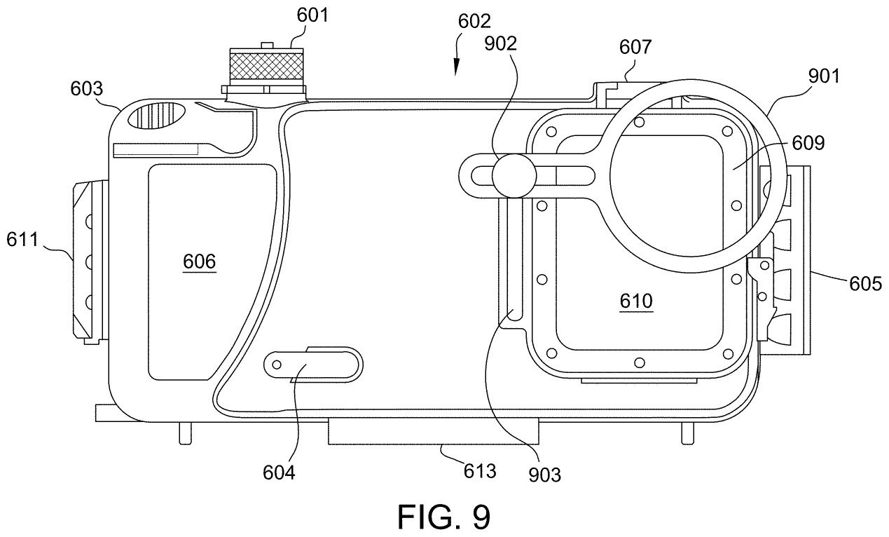

As shown in FIG. 9, case 202 may include a lens holder accessory 901. In some embodiments, lens holder 901 may be attached to a housing lens port frame of the case. Additionally, lens holder 901 may be used to attach a lens to the case. For example, a wide-angle or close-up lens accessory may be attached to the case via lens holder 901. Other types of lenses may be attached, such as a fisheye lens, for example. The type of lens that may be attached is not meant to be limiting. Lens holder 901 may be moved along an X-Y axis via locking bolt 902 moving holder left and ride and up and down slide 903.

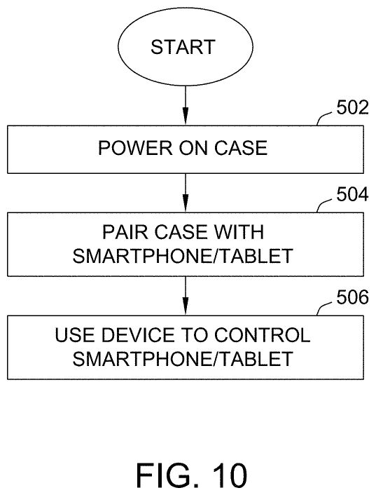

FIG. 10 illustrates an exemplary process in accordance with at least one embodiment of the present disclosure. An underwater case may encapsulate a device for use in wet and dry conditions, such as underwater, extreme hot or cold conditions, or the like. The underwater case may include one or more waterproof seals to keep an encapsulated device safe from the elements. The case may include a controller including a non-volatile memory and processor. Upon power on 502, radio module may provide a short-range wireless connection between the controller and the device. Once connected, the case may pair 504 with the encapsulated device. In some embodiments, the case may pair with the device via a Bluetooth® connection, or the like, via an integrated connection module. Additionally, or alternatively, the integrated connection module may activate the device. The case may include one or more input components, described herein, that may be used to control 506 the encapsulated device. As a user makes one or more inputs, such as from a joystick or trackball, instructions may be transmitted from the case to the device.

It is appreciated that exemplary computing system 100 is merely illustrative of a computing environment in which the herein described systems and methods may operate, and thus does not limit the implementation of the herein described systems and methods in computing environments having differing components and configurations. That is, the inventive concepts described herein may be implemented in various computing environments using various components and configurations.

Those of skill in the art will appreciate that the herein described apparatuses, engines, devices, systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the disclosure, any appended claims and any equivalents thereto.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

1. An underwater case for containing a device, comprising:
one or more waterproof seals;
a controller comprising a non-volatile memory and processor, the controller comprising:
a radio module configured to provide a short-range wireless connection between the controller and the device; and
an integrated connection module configured to activate the device;
an input component connected to the controller and configured to:
receive one or more inputs from a user; and
transmit, via the short-range wireless connection, an instruction to the device based on the one or more inputs.

2. The underwater case of claim 1, wherein the device is at least one of a camera, a mobile device, a smartphone device, and a tablet.

3. The underwater case of claim 1, wherein the instruction performs an action on the device.

4. The underwater case of claim 3, wherein the action causes a native application of the device to be performed.

5. The underwater case of claim 1, further comprising:
a door movable between an open and closed position.

6. The underwater case of claim 5, wherein the door includes a transparent screen.

7. The underwater case of claim 6, wherein the transparent screen is comprised of glass, plastic, or a combination thereof.

8. The underwater case of claim 1, wherein the input component includes at least one of: a capacitance interface, a joystick, button, lever, switch and a trackball.

9. The underwater case of claim 1, wherein an on-screen cursor on a display of the device mimics movement of the input component.

10. A case for containing a device, comprising
a device comprising at least one of, a camera, mobile telephone, smartphone, and tablet;
a controller arranged on a portion of a case for activating said device;
an integrated connection module in wireless mode for activating the device by the controller;
a door for sealing the interior of the case from water intrusion in a submersed environment, comprising a transparent screen for viewing the device inside the case;
a radio module for supporting a Bluetooth standard, and wherein data exchange between the underwater case and the device takes place using the Bluetooth standard; and
at least one selection device in communication with the controller for controlling at least one feature of the device.

11. The case of claim 10, wherein the case further comprises an integrated pressure sensor that measures underwater depth.

12. The case of claim 11, wherein said pressure sensor communicates the depth data to the device via wireless radio frequency.

13. The case of claim 10, wherein the case further comprises an electrical switch inside the case for powering the case on and off.

14. The case of claim 10, wherein the case further comprises any type of adaptor used for attaching an underwater photo-video light accessory, underwater lens accessory and mounting tray, grip, handle, or lanyard.

15. The case of claim 10, wherein the case further comprises a water sensor for detecting water intrusion.

16. The case of claim 10, wherein the case further comprises a joystick, trackball, or other X-Y or X-Y-Z cursor moving device assembly that is removable.

17. The case of claim 10, wherein the case further comprises a vacuum pressure port.

18. The case of claim 10, wherein the case further comprises a holding spring acting on the device.

19. A method for using a device in an underwater environment, the method comprising:
placing a smartphone in a case having at least one waterproof seal;
paring the smartphone with a controller comprising a non-volatile memory and processor, the controller comprising:
a radio module configured to provide a short-range wireless connection between the controller and the device; and
an integrated connection module configured to activate the device; and
receiving one or more inputs from a user through an input component connected to the controller; and
transmitting an instruction to the device based on the one or more inputs.
